(19) United States
(12) Patent Application Publication
(10) Pub. No.: US 2008/0268092 A1
(43) Pub. Date: Oct. 30, 2008

(54) Capsaicin Nutritional Supplement

(76) Inventor: Rhodel G. Dacanay, Poway, CA (US)

Correspondence Address: MORRISON & FOERSTER LLP, 12531 HIGH BLUFF DRIVE, SUITE 100, SAN DIEGO, CA, 92130-2040, US

(21) Appl. No.: 11/720,738

(22) PCT Filed: Dec. 1, 2005
(86) PCT No.: PCT/US2005/043358

§ 371 Date: Jun. 23, 2008

Related U.S. Application Data
(60) Provisional application No. 60/632,633, filed on Dec. 1, 2004.

(51) Int. Cl. A23L 1/30

(52) U.S. Cl. 426/2; 426/648

(57) ABSTRACT

Compositions comprising a synergistic combination of a vanilloid receptor subtype 1 agonist and a methylxanthine as a nutritional supplement and uses thereof.

### TECHNICAL FIELD

The present invention relates to the use of a synergistic combination of a vanilloid receptor subtype 1 agonist and a methylxanthine as a nutritional supplement.

### BACKGROUND ART

Capsaicin is the compound that causes the sensation of heat felt when one eats chile peppers. Capsaicin is a crystalline alkaloid produced as a natural plant product. Capsaicin is both powerful and stable. It is largely unaffected by cold or heat. It is hydrophobic and only slightly soluble in water.

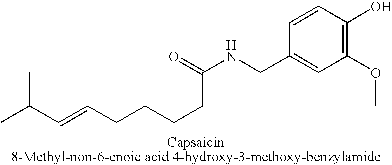

Capsaicin binds the vanilloid receptor subtype 1 (VR1), which is an ion channel-type receptor. VR1, which is also activated by heat and physical force, depolarizes neronal membrane upon activation. The resulting neuronal depolarization is transmitted to the brain. By binding to the VR1 receptor, the capsaicin molecule produces the neuronal depolarization that is produced by exposure to heat or physical input. The triggering of VR1 explains why consumption of capsaicin is described as a burning sensation.

The word capsaicin generically describes a complex of related compounds called capsaicinoids. Five naturally occurring members of the family have thus far been isolated and identified: trans-8-methyl N-vanillyl 6-nonenamide, 8-methyl N-vanillyl nonamide, 7-methyl N-vanillyl octamide, 9-methyl N-vanillyl decamide, and trans-9-methyl N-vanillyl 7-decenamide.

In addition to its uses as a spice, capsaicin has been shown to increase endurance capacity in animal models. Capsaicin has also been shown to increase metabolic rates and stimulate adrenergic receptors. Capsaicin in combination with green tea extract and essence of chicken has been shown to reduce body fat content in humans. Capsaicin has also been shown to promote lipolysis in animal models.

Other vanilloid receptor agonists and capsaicin analogues (including; but not limited to, capsiate, evodiamine, thiourea derivatives, or CH-19 Sweet) have been shown to have similar effects.

Methylxanthines, including caffeine, have been shown to directly or indirectly stimulate adrenergic receptors, act as a central nervous system stimulant, promote lipolysis or weight loss, and/or increase metabolic rate. Methylxanthines have also been shown to improve exercise capacity, and endurance. The combination of methylxanthines and other adrenergic agonists, such as ephedrine, appears to have additive or synergistic effects.

Xanthine is a purine base that is found in most body tissues and fluids. Methylxanthine is a methylated derivative of xanthine. Examples of interesting methylxanthines include caffeine, theobromine, theophylline and its synthetic analog aminophylline (theophylline ethylenediamine. Major sources of these methylxanthines include coffee, cocoa, cola nut, black teas, and food products such as chocolates.

### SUMMARY OF THE INVENTION

The described invention relates to a nutritional supplement comprising a vanilloid receptor agonist, a methylxanthine, contained within a delivery vehicle, wherein the vanilloid receptor agonist and the methylxanthine are present in synergistic quantities, such that a subject, upon administration of the nutritional supplement experiences increased physical performance or improved cognitive performance, improve mood and decrease appetite as compared to the subject's physical performance without administration of the nutritional supplement.

### MODES OF CARRYING OUT THE INVENTION

The invention described relates to compositions and methods of using compositions comprising a combination of one or more vanilloid receptor agonists and one or more methylxanthine compounds in a nutritional supplement. The disclosed compositions are effective to boost energy, increase alertness, mental concentration, mental focus, wakefulness, exercise power, exercise capacity, or exercise endurance.

### Synergistic Combination of Vanilloid Receptor Agonist and Methylxanthines

The disclosed invention exploits the stimulatory capabilities of vanilloid receptor agonists and methylxanthines. Vanilloid receptor agonists are well known in the art. Examples of typical vanilloid receptor agonists include but are not limited to capsaicin, evodiamine, thiourea derivatives (including, but not limited to, resiniferatoxin), and products of the ch-19 sweet pepper.

More generally, the term “capsaicin” or vanilloid receptor analog encompasses a compound of the general formula:

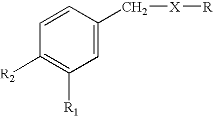

wherein R₁ is selected from the group consisting of OH and OCH₃, R₂ is selected from the group consisting of:

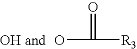

R₃ is selected from the group consisting of a C₁-C₄ alkyl, phenyl, and methyl, X is selected from the group consisting of

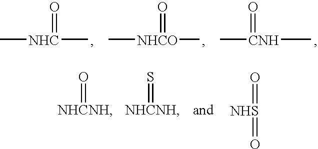

and R is selected from the group consisting of a C₅-C₁₁ alkyl, C₅-C₁₁ alkenyl, C₁₁-C₂₃ cis alkenyl, C₁₁-C₂₃ alkynyl, C₁₁-C₂₃ alkadienyl and C₁₁-C₂₃ methylene substituted alkane.

Preferred compounds include those wherein both R₁ and R₂ are OH and X is

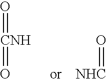

and those wherein R₁ is OCH₃, R₂ is OH or R₃ CO and X is

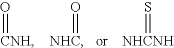

Preferred R groups include C₇-C₁₀ alkyls and trans alkenyls, and C₁₆-C₂₁ cis alkenyls and alkadienyls. The preferred moieties within these groups include C₈H₁₇, C₉H₁₇ and C₁₇H₃₃. Preferred capsaicin analogs include N-vanillyl-alkadienamides, N-vanillyl-alkanedienyls, and N-vanillyl-cis-monounsaturated alkenamides. A particularly preferred capsaicinoid is N-vanillyl-9Z-octadecenamide (N-vanillyloleamide).

Preferred capsaicin analogs and methods for their preparation are described in U.S. Pat. Nos. 4,313,958, 4,493,848, 4,532,139, 4,544,668, 4,544,669, and 4,812,446, all of which are hereby incorporated by reference in their entirety.

The disclosed synergistic combinations use one or more vanilloid receptor agonists in conjunction with one or more methylxanthines. Vanilloid receptor agonists are selected primarily for their ability to improve performance and mental acuity without regard to the stimulatory nature of the compounds. However, more pungent agonists can be used with less pungent agonists to moderate the stimulatory effects of the agonists.

One or more methylxanthines such as caffeine, theobromine, theophylline and its synthetic analog aminophylline (theophylline ethylenediamine) are combined with one or more vanilloid receptor agonists to produce a metabolic stimulant.

A preferred embodiment of the described invention comprises a synergistic combination of one or more vanilloid receptor agonist with one or methylxanthines. Examples of suitable forms that may comprise the combination include powders, tablets, capsules, spray (oral or nasal), drinks, gels, gums, food stuffs, such as bars, mixes, liquid concentrates, suppositories, etc.

The compositions of the disclosed invention are administered via any suitable route including but not limited to ingestion, parenteral routes such as intravenous, transdermal, transmucosal, intranasal, inhalation and the like.

Other ingredients are also contemplated for use with the synergistic combination disclosed herein. For example, various vitamins and minerals can be included along with the disclosed synergistic combination. Examples of such vitamins and minerals include vitamins A, B₁, B₂, B₃, B₅, B₆, B₉, B₁₂, C, D, E, calcium, phosphate, iron, manganese, copper, iodide, chromium and others.

Amino acids are also contemplated for use with the disclosed synergistic combination. Examples of suitable amino acids include L-arginine, L-aspartic acid, branched-chain amino acids, L-cysteine (and glutathione), L-glutamine/L-glutamic acid, glycine, L-histidine, L-lysine, L-methionine, L-phenylalanine, D-phenylalanine, DL-phenylalanine, L-tryptophan, and L-tyrosine

Other ingredients contemplated for use in the disclosed products include taurine, carnitine, nicotine, ephedrine, ginko biloba, guarana seed extract, ascorbic acid, inositol and others.

Dosing of vanilloid receptor agonists and methylxanthines can be determined empirically, using standard methods well known to those of ordinary skill in the art. Preferred concentrations of vanilloid receptor agonists range from 20-80 mg per dose. Alternatively, dosing regimens for capsaicin range from 0.1-20 mg/kg or equipotent doses of other vanilloid receptor agonists. Preferred concentrations of methylxanthines range from 20-60 mg per dose. Alternatively, dosing regimens for methylxanthines can range from 0.1-8 mg/kg or equipotent doses of other methylxanthine compounds.

The pharmacokinetics of methylxanthines such as caffeine are fairly well studied and indicate that caffeine is rapidly and completely absorbed in humans, with 99 percent being absorbed within 45 minutes of ingestion. Peak plasma concentrations occur between 15 and 120 minutes after oral ingestion, and may be influenced by route of administration, the form of administration, or other components of the diet. Once caffeine is absorbed, it is distributed rapidly throughout body water. However, caffeine is also sufficiently lipophilic to pass through all biological membranes and readily crosses the blood-brain barrier. The mean half-life of caffeine in plasma of healthy individuals is about 5 hours, although its half-life may range between 1.5 and 9.5 hours. (Caffeine for the Sustainment of Mental Task Performance: Formulations for Military Operations (2001); Institute of Medicine (IOM); NATIONAL ACADEMY PRESS 2101 Constitution Avenue, NW Washington, D.C. 20418)

The pharmacokinetics of capsaicin are not completely known, however, it is reasonable to presume that based on the presence of both hydrophilic and lipophilic moieties that it's pharmacokinetic profile would be similar to that of caffeine. What has not been studied is the metabolism and excretion profile of capsaicin or the production of active metabolites within the human body; however, current use in the nutraceuticals field suggests that dosing should occur every 4-12 hours. Low-dose or specific use regimens may require re-dosing more or less frequently.

Personal experience indicates that capsaicin use boosts energy, increases exercise capacity, increases endurance, improves mood, decreases appetite and increases alertness in humans. In addition, these effects seem to be potentiated, possibly in an additive or synergistic manner, by the addition of caffeine.

The dosing ranges and suggested usage regimens given are provided as examples only and are based on current data and use in the nutraceutical field. Therefore, the dosing examples and usage regimens given do not in any way limit the scope of this patent application which is for the synergistic combination of methylxanthine(s) and vanilloid receptor agonist(s) in any combination and in any doses as a nutritional supplement for the purpose of boosting energy; improving alertness, vigilance, mental focus, mental concentration, wakefulness, or mood; or for increasing exercise capacity, endurance, or power. To this end, this patent also applies to the synergistic combination of methylxanthine(s) and vanilloid receptor agonist(s) in any combination and in any doses as a nutritional supplement for the above-stated purposes even when combined with other ingredients listed within this patent application as well as with other ingredients not specifically listed herein.

The following examples are offered to illustrate but not to limit the invention.

### EXAMPLE 1

### Improved Physical Performance

In this example a subject's physical performance parameters are measured both with and without the administration of the methylxanthine(s) and vanilloid receptor agonist(s) combination which can occur via any route or embodiment; which occurs from 3 hours prior to exertion to immediately prior to exertion; and which may or may not be re-dosed at various intervals of about 1 to 6 hours throughout the assessment. Measured parameters may include maximum power output, maximum sustained power output, time to exhaustion at 80% of maximal exertion, maximum oxygen uptake/utilization, performance on repetitive exhaustive exercises (improved exercise recovery), measurement of lactic acid production or subjective/perceived effort at preset workloads, or others. These parameters are most easily measured on a cycling ergometer; however, other devices such as a treadmill may be used. The subject's performance, as measured by these parameters, after a recovery period between trials, will be improved with the administration of the methylxanthine(s) and vanilloid receptor agonist(s) combination.

### EXAMPLE 2

### Improved Cognitive Performance

In this example a subject's cognitive performance will be assessed both with and without the administration of the methylxanthine(s) and vanilloid receptor agonist(s) combination which can occur via any route or embodiment; which occurs from 3 hours prior to assessment to immediately prior to assessment; and which may or may not be re-dosed at various intervals of about 1 to 6 hours throughout the assessment. Cognitive performance assessment can include the measurement of vigilance and reaction times to alarms, radar displays, or driving simulations in the performance of prolonged and/or tedious tasks; tests of memory and learning; performance of skilled or detailed tasks; subjective measurement of mood, wakefulness, alertness, or vigilance; etc. in both rested and sleep-deprived states. Performance on these assessed parameters will be improved with the administration of the methylxanthine(s) and vanilloid receptor agonist(s) combination.

### EXAMPLE 3

### Improved Mood

In this example a subject's mood or mental sense of well being will be assessed both with and without the administration of the methylxanthine(s) and vanilloid receptor agonist(s) combination which can occur via any route or embodiment; which occurs from 3 hours prior to assessment to immediately prior to assessment; and which may or may not be re-dosed at various intervals of about 1 to 6 hours throughout the assessment. Mood assessment can include the measurement of responses to questions regarding ones outlook on life and their general sense of self. Performance on these assessed parameters will be improved with the administration of the methylxanthine(s) and vanilloid receptor agonist(s) combination.

### EQUIVALENTS

Those skilled in the art will recognize, or be able to ascertain, using no more than routine experimentation many equivalents to the specific embodiments of the invention described herein. Such equivalents are intended to be encompassed by the following claims:

1. A nutritional supplement comprising:
a vanilloid receptor agonist and a methylxanthine; and
a delivery vehicle, wherein the vanilloid receptor agonist and the methylxanthine are present in the delivery vehicle in synergistic quantities, such that a subject, upon administration of the nutritional supplement experiences increased performance as compared to the subject's performance without administration of the nutritional supplement.

2. The nutritional supplement of claim 1, wherein the vanilloid receptor agonist is an agonist of a vanilloid receptor subtype 1 (VR1).

3. The nutritional supplement of claim 1, wherein the vanilloid receptor analog encompasses a compound of the general formula: 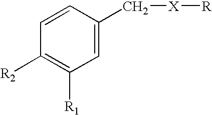
wherein R₁ is selected from the group consisting of OH and OCH₃, R₂ is selected from the group consisting of: 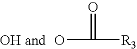
where R₃ is selected from the group consisting of a C₁-C₄ alkyl, phenyl, and methyl, X is selected from the group consisting of 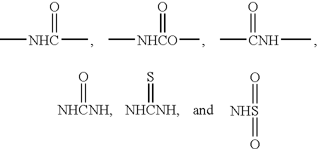
and R is selected from the group consisting of a C₅-C₁₁ alkyl, C₅-C₁₁ alkenyl, C₁₁-C₂₃ cis alkenyl, C₁₁-C₂₃ alkynyl, C₁₁-C₂₃ alkadienyl and C₁₁-C₂₃ methylene substituted alkane.

4. The nutritional supplement of claim 3, wherein both R₁ and R₂ are OH and X is 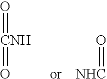
and those wherein R₁ is OCH₃, R₂ is OH or R₃ CO and X is

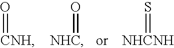

5. The nutritional supplement of claim 3, wherein R groups comprise C₇-C₁₀alkyls, trans alkenyls, C₁₆-C₂₁ cis alkenyls and alkadienyls.

6. The nutritional supplement of claim 1, wherein the vanilloid receptor agonist is selected from the group consisting of trans-8-methyl N-vanillyl 6-nonenamide, 8-methyl N-vanillyl nonamide, 7-methyl N-vanillyl octamide, 9-methyl N-vanillyl decamide, and trans-9-methyl N-vanillyl 7-decenamide.

7. The nutritional supplement of claim 1, wherein the methylxanthine is selected from the group consisting of caffeine, theobromine, theophylline and its synthetic analog aminophylline (theophylline ethylenediamine).

8. The nutritional supplement of claim 1, further comprising taurine, carnitine, nicotine, ephedrine, ginko biloba, guarana seed extract, ascorbic acid, and inositol.

9. The nutritional supplement of claim 1, wherein the supplement is compounded in a form selected from the group consisting of tablets, capsules, spray (oral or nasal), drinks, gels, gums, food stuffs, such as bars, mixes, liquid concentrates, and suppositories.

10. Use of synergistic quantities a vanilloid receptor agonist, a methylxanthine and a delivery vehicle, for the preparation of a nutritional supplement to improve a subject's performance.

11. The use of claim 10, wherein physical performance of the subject is improved.

12. The use of claim 11, wherein conditions of physical performance are selected from the group consisting of exercise power, capacity, energy, and endurance.

13. The use of claim 10, wherein the performance is cognitive performance.

14. The use of claim 13, wherein the cognitive performance is selected from the group consisting of energy, alertness, mental concentration, mental focus, wakefulness, vigilance and mood.

15. The use of claim 10, wherein performance is measured by the ability to function without hunger.

16. A method to enhance the physical performance of a subject, comprising administering the nutritional supplement of claim 1.

17. The method of claim 16, wherein conditions of physical performance are selected from the group consisting of exercise power, capacity, energy, and endurance.

18. The method of claim 16, wherein the performance is cognitive performance.

19. The method of claim 18, wherein conditions of cognitive performance are selected from the group consisting of energy, alertness, mental concentration, mental focus, wakefulness, vigilance and mood.

20. A method to reduce appetite in a subject, comprising administering the nutritional supplement of claim 1.
